(19) United States
(12) Patent Application Publication
(10) Pub. No.: US 2026/0214753 A1
(43) Pub. Date: Jul. 23, 2026

(54) DETECTION DEVICE AND FLUID HEATING DEVICE

(71) Applicant: AISAN KOGYO KABUSHIKI KAISHA, Obu-shi (JP)

(72) Inventors: Tomonori NAGASE, Chita-gun (JP); Makoto NAKAGAWA, Nagoya-shi (JP); Hiroyuki TAKAHASHI, Nagoya-shi (JP); Nobuo OGASAWARA, Handa-shi (JP)

(21) Appl. No.: 19/417,521

(22) Filed: Dec. 12, 2025

(30) Foreign Application Priority Data
Jan. 16, 2025 (JP) 2025-006145

(51) Int. Cl. H05B 1/02; F24H 9/20; H05B 3/00; H05B 3/12; H05B 3/18; H05B 3/78

(52) U.S. Cl. CPC H05B 1/0297; F24H 9/20; H05B 3/0019; H05B 3/12; H05B 3/18; H05B 3/78; H05B 2203/021

(57) ABSTRACT

A detection device may include a conductive wire attached to a surface of an outer tube of the sheathed heater; and a detector configured to detect a current flowing through the outer tube of the sheathed heater via the conductive wire.

### CROSS REFERENCE TO RELATED APPLICATION

This application claims priority to Japanese Patent Application No. 2025-006145 filed on Jan. 16, 2025. The entire content of the priority application is incorporated herein by reference.

### TECHNICAL FIELD

The art disclosed herein relates to a detection device for detecting leakage current of a sheathed heater, and a fluid heating device.

### BACKGROUND ART

Japanese Patent Application Publication No. 2005-90872 describes a fluid heating device. The fluid heating device of Japanese Patent Application Publication No. 2005-90872 includes a fluid heating container having a fluid inlet and a fluid outlet, a sheathed heater extending through the fluid heating container, a thermistor disposed outside the fluid heating container and configured to detect the temperature of the sheathed heater, and a control means for controlling the sheathed heater. The fluid heating device of Japanese Patent Application Publication No. 2005-90872 can control the temperature of the fluid and perform safety measures such as prevention of dry boiling.

The configuration of the device described in Japanese Patent Application Publication No. 2005-90872 is complex due to the use of thermistor. The use of thermistor may cause an increase in the weight of the device and/or cost. The disclosure herein provides a technology for preventing a heater from continuing to run in a dry-boiling state without using a thermistor.

### SUMMARY

A detection device for detecting leakage current of a sheathed heater is disclosed herein. The sheathed heater may comprise a metal outer tube, a heating element housed in the outer tube, and a magnesium oxide insulating material filling the outer tube around the heating element. The detection device may comprise a conductive wire attached to a surface of the outer tube of the sheathed heater and a detector configured to detect a current flowing through the outer tube of the sheathed heater via the conductive wire.

A fluid heating device is also disclosed herein. The fluid heating device may comprise a housing that houses fluid to be heated; a sheathed heater attached to the housing and configured to heat the fluid housed in the housing; and a detection device configured to detect leakage current of the sheathed heater. The sheathed heater may comprise a metal outer tube made, a heating element housed in the outer tube, and a magnesium oxide insulating material filling the outer tube around the heating element. The detection device may comprise a conductive wire attached to a surface of the outer tube of the sheathed heater and a detector configured to detect a current flowing through the outer tube of the sheathed heater via the conductive wire.

### BRIEF DESCRIPTION OF DRAWINGS

FIG. 1 is a diagram schematically illustrating a detection device and a fluid heating device according to an embodiment.

FIG. 2 is a cross-sectional view of a sheathed heater according to an embodiment.

FIG. 3 is a cross-sectional view taken along III-III in FIG. 1.

FIG. 4 is an enlarged view of an area IV in FIG. 1.

### DETAILED DESCRIPTION

In one aspect of the present teachings, a detection device for detecting leakage current of a sheathed heater is disclosed. The sheathed heater may comprise a metal outer tube, a heating element housed in the outer tube, and a magnesium oxide insulating material filling the outer tube around the heating element. The detection device may comprise a conductive wire attached to a surface of the outer tube of the sheathed heater and a detector configured to detect a current flowing through the outer tube of the sheathed heater via the conductive wire.

When running in dry-boiling state, the sheathed heater may reach a high temperature since the heat from the heating element is not absorbed by fluid to be heated. The high-temperature sheathed heater may cause a reduction in the electrical resistance of the magnesium oxide insulating material, which may lead to a leakage of current flowing through the heating element to the outer tube of the sheathed heater via the insulating material. The configuration above can detect current leaked to the outer tube of the sheathed heater via the conductive wire. Thus, the configuration above can detect whether the sheathed heater is running in a dry-boiling state and prevent the sheathed heater from continuing to run in the dry-boiling state without using a thermistor.

In one embodiment of the present teachings, the detection device may further comprise a controller configured to cut off a current to the heating element when the detector detects the current flowing through the outer tube of the sheathed heater. This configuration can prevent the sheathed heater from reaching a higher temperature, thereby preventing the sheathed heater from continuing to run in the dry-boiling state.

In one embodiment of the present teachings, the sheathed heater may be attached to a housing that houses fluid to be heated in an electrically insulated manner from the housing. This configuration can prevent current leaked to the outer tube of the sheathed heater from leaking to the housing.

In one embodiment of the present teachings, the sheathed heater may be electrically insulated from the housing by a sealing member disposed between the sheathed heater and the housing.

This configuration ensures the insulation between the sheathed heater and the housing. Further, the configuration can prevent the fluid housed in the housing from leaking between the sheathed heater and the housing.

In one embodiment of the present teachings, the conductive wire may be attached to the surface of the outer tube of the sheathed heater at a position closer to an axial end of the sheathed heater than the sealing member is. This configuration allows the conductive wire to be easily pulled out.

In one aspect of the present teachings, a fluid heating device may comprise a housing that houses fluid to be heated; a sheathed heater attached to the housing and configured to heat the fluid housed in the housing; and a detection device configured to detect leakage current of the sheathed heater. The sheathed heater may comprise a metal outer tube made, a heating element housed in the outer tube, and a magnesium oxide insulating material filling the outer tube around the heating element. The detection device may comprise a conductive wire attached to a surface of the outer tube of the sheathed heater and a detector configured to detect a current flowing through the outer tube of the sheathed heater via the conductive wire.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved detection devices and fluid heating devices.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

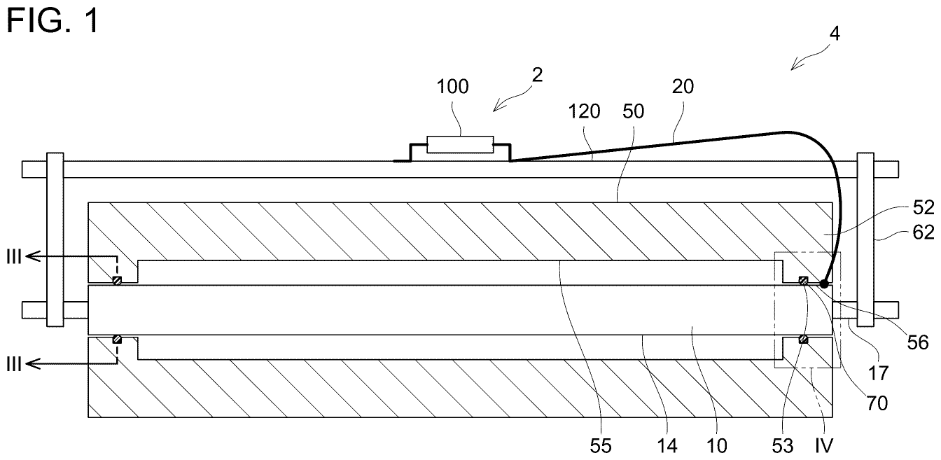

Referring to the drawings, a detection device 2 and a fluid heating device 4 according to an embodiment are described. As illustrated in FIG. 1, the detection device 2 according to the present embodiment is applied to a sheathed heater 10. The detection device 2 is configured to detect leakage current of the sheathed heater 10. The fluid heating device 4 according to the present embodiment comprises a housing 50 that houses fluid to be heated, the sheathed heater 10 attached to the housing 50 and configured to heat the fluid housed in the housing 50, and the detection device 2 configured to detect leakage current of the sheathed heater 10.

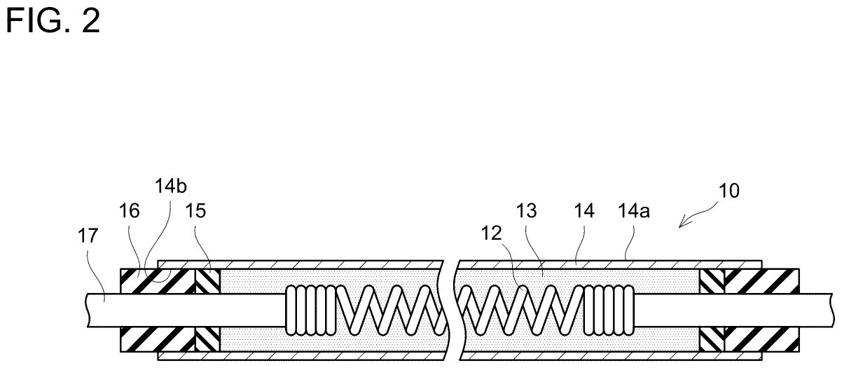

Now, the sheathed heater 10 is described. As illustrated in FIG. 2, the sheathed heater 10 comprises an outer tube 14, a heating element 12 disposed within the outer tube 14, and an insulating material 13 filling the outer tube 14. The sheathed heater 10 further comprises a terminal 17 inserted in an opening 14b of the outer tube 14 and a seal (a first seal 15 and a second seal 16) sealing the opening 14b of the outer tube 14. The sheathed heater 10 can heat the fluid to be heated by the heating element 12 generating heat. The object to be heated by the sheath heater 10 may be but not particularly limited to a liquid such as water or a coolant.

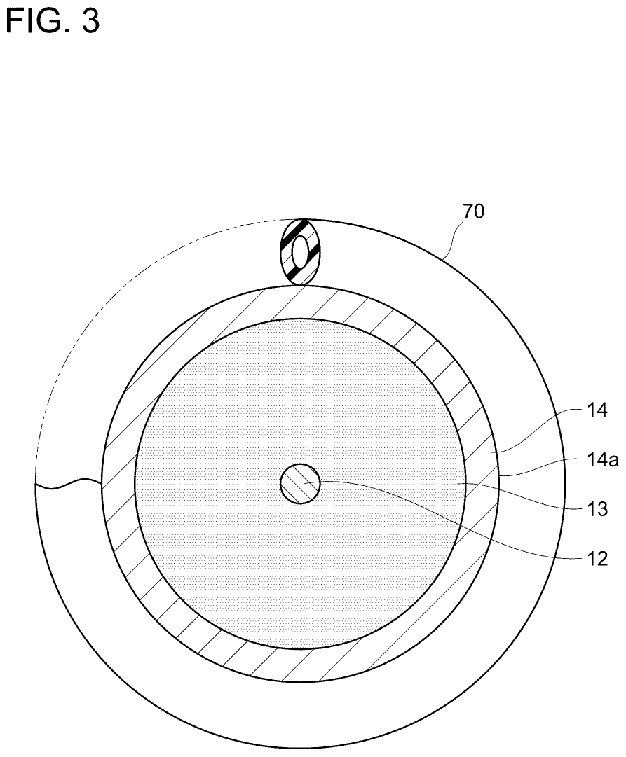

The outer tube 14 is constituted of a metal material such as stainless steel (SUS) and is thermally and electrically conductive. The metal material of the outer tube 14 is not limited to a particular one. An axial end of the outer tube 14 is sealed by the seal (the first seal 15 and the second seal 16). Axially opposing ends of the outer tube 14 are both sealed by seals. As illustrated in FIG. 3, in a cross-sectional view perpendicular to the axis of the outer tube 14, the outer tube 14 has a circular cross section. In a variant, in a cross-sectional view perpendicular to the axis of the outer tube 14, the outer tube 14 may have an oval or polygonal cross section. The shape of cross section of the outer tube 14 is not limited to a particular shape.

The heating element 12 comprises, for example, a nichrome wire wound in a helical shape. The heating element 12 extends along the axis of the outer tube 14. The heating element 12 is thermally and electrically conductive and generates heat when current flows therethrough.

The insulating material 13 comprises magnesium oxide (MgO) powder. The insulating material 13 fills a gap between the outer tube 14 and the heating element 12. In other words, the insulating material 13 fills the outer tube 14 around the heating element 12. The insulating material 13 electrically insulates the heating element 12 from the outer tube 14, but its electrical resistance may decrease at high temperatures. Thus, when the insulating material 13 reaches a high temperature, current flowing through the heating element 12 may leak to the outer tube 14 via the insulating material 13.

The terminal 17 extends both inside and outside the outer tube 14. An end of the terminal 17 is connected to the heating element 12 inside the outer tube 14, and the opposite end of the terminal 17 is connected to a busbar 62 (see FIG. 1) outside the outer tube 14.

The busbar 62 is electrically conductive and electrically connected to an external power supply (not illustrated). The terminal 17 of the sheathed heater 10 is electrically connected to the power supply (not illustrated) via the busbar 62. Power is supplied from the external power supply to the heating element 12 through the busbar 62 and the terminal 17.

As illustrated in FIG. 2, the terminal 17 of the sheathed heater 10 is supported by the seal (the first seal 15 and the second seal 16) sealing the outer tube 14. In the axial direction of the sheathed heater 10, the first seal 15 is positioned more inward of the outer tube 14 than the second seal 16 (i.e., the second seal 16 is positioned more outward of the outer tube 14 than the first seal 15). For example, the first seal 15 is constituted of a glass material and the second seal 16 is constituted of a ceramic material. The material of the seal (the materials of the first seal 15 and the second seal 16) is not limited to a particular material.

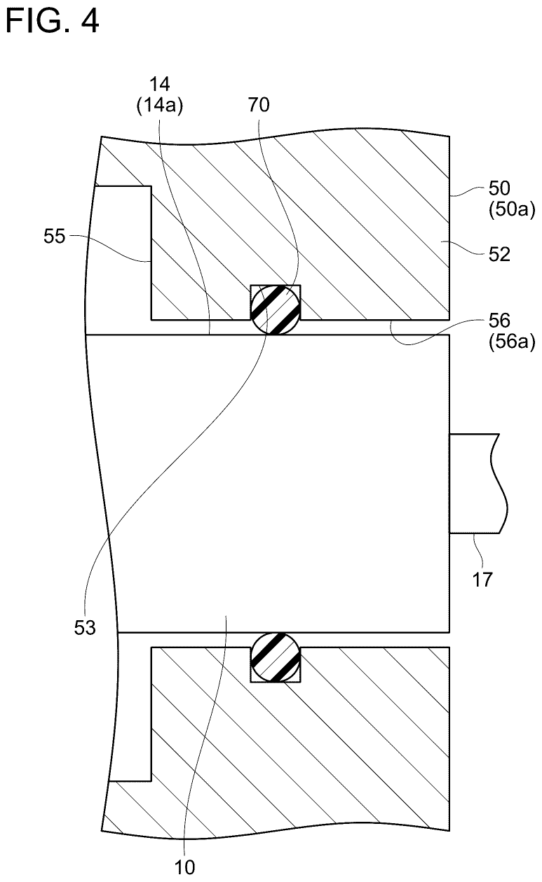

Now, the housing 50 that houses the fluid to be heated by the sheathed heater 10 is described (see FIGS. 1 and 4). For example, the housing 50 is constituted of a metal material such as a metal alloy containing aluminum. The housing 50 is thermally and electrically conductive. The housing 50 comprises an insert hole 56 for insertion of the sheathed heater 10, a support 52 for supporting the sheathed heater 10, and a flow passage 55 through which the fluid to be heated by the sheath heater 10 flows. The sheathed heater 10 is inserted in the insert hole 56 of the housing 50 and supported by the support 52. The sheathed heater 10 heats the fluid flowing through the flow passage 55 while being supported by the support 52. The sheathed heater 10 is attached to the housing 50 in an electrically insulated manner from the housing 50.

The insert hole 56 penetrates a side surface portion 50a of the housing 50, and the interior and exterior of the housing 50 communicate through the insertion hole 56. The sheathed heater 10 is inserted in the insert hole 56 of the housing 50. There is a gap between an inner surface 56a of the insert hole 56 and an outer peripheral surface 14a of the outer tube 14 of the sheathed heater 10. Thus, the inner surface 56a of the insert hole 56 does not contact the outer peripheral surface 14a of the outer tube 14 of the sheathed heater 10 and is separated therefrom. In other words, the housing 50 does not contact the sheathed heater 10 and is separated therefrom.

The support 52 supports the outer peripheral surface 14a of the outer tube 14 of the sheathed heater 10 inserted in the insert hole 56. The support 52 supports the outer peripheral surface 14a of the outer tube 14 of the sheathed heater 10 via a sealing member 70. The support 52 does not contact the sheathed eater 10 and is separated therefrom by the sealing member 70. The support 52 comprises a housing recess 53 for receiving the sealing member 70.

For example, the sealing member 70 is constituted of an insulating material such as resin. The sealing member 70 is elastic and electrically insulating. The sealing member 70 is disposed between the sheathed heater 10 and the housing 50 and electrically insulates the sheathed heater 10 from the housing 50. The sealing member 70 is received in the housing recess 53 defined in the support 52 of the housing 50.

The sealing member 70 is in close contact with the outer peripheral surface 14a of the outer tube 14 of the sheathed heater 10. The sealing member 70 continuously extends around the outer peripheral surface 14a of the outer tube 14 of the sheathed heater 10 so as to surround the outer peripheral surface 14 a of the outer tube 14. The sealing member 70 seals the gap between the outer peripheral surface 14a of the outer tube 14 of the sheathed heater 10 and the support 52. The sealing member 70 seals the gap between the outer peripheral surface 14a of the outer tube 14 of the sheathed heater 10 and the inner surface 56a of the insert hole 56. As illustrated in FIG. 3, the sealing member 70 is configured as an O-ring having an O-shaped cross section.

Now, the detection device 2 for detecting leakage current of the sheathed heater 10 is described. As illustrated in FIG. 1, the detection device 2 comprises a conductive wire 20 attached to the outer tube 14 of the sheathed heater 10 and a control unit 100.

One end of the conductive wire 20 is electrically connected to the outer tube 14 of the sheathed heater 10, and the opposite end of the conductive wire 20 is electrically connected to the control unit 100. When current flows through the outer tube 14 of the sheathed heater 20, current also flows through the conductive wire 20. The one end of the conductive wire 20 is attached to the outer peripheral surface 14a of the outer tube 14 of the sheathed heater 10. The one end of the conductive wire 20 is attached to the outer peripheral surface 14a of the outer tube 14 of the sheathed heater 10 at a position closer to an axial end of the sheathed heater 10 than the sealing member 70 is. That is, the one end of the conductive wire 20 is attached to the outer peripheral surface 14a of the outer tube 14 of the sheathed heater 10 at a position on the opposite side to the flow passage 55 with respect to the sealing member 70. In a variant, the one end of the conductive wire 20 may be attached to a surface other than the outer peripheral surface 14a of the outer tube 14 of the sheathed heater 10 (e.g., to an axial end surface of the outer tube 14).

The control unit 100 is fixed to a substrate 120. The substrate 120 is supported by the busbar 62. The control unit 100 is configured to detect current flowing through the outer tube 14 of the sheathed heater 10 via the conductive wire 20. Thus, the control unit 100 can detect leakage current of the sheathed heater 10. Further, the control unit 100 cuts off current to the heating element 12 of the sheathed heater 10 in response to detecting current flowing through the outer tube 14 of the sheathed heater 10. For example, the control unit 100 cuts off the current to the heating element 12 by turning off the power supply (not illustrated) of the sheathed heater 10. When the current to the heating element 12 is cut off, the heating element 12 ceases to generate heat. Thus, the sheathed heater 10 ceases to heat the fluid to be heated.

(Advantageous Effects) The detection device 2 and the fluid heating device 4 according to an embodiment have been described. In the fluid heating device 4 described above, the sheathed heater 10, when running dry, may reach a high temperature since the heat from the heating element 12 is not absorbed by the fluid to be heated. The high-temperature sheathed heater 10 may cause a reduction in the electrical resistance of the magnesium oxide insulating material 13, which may lead to leakage of a current flowing through the heating element 12 to the outer tube 14 of the sheathed heater 10 via the insulating material 13.

The detection device 2 according to the above embodiment comprises the conductive wire 20 attached to the outer peripheral surface 14a of the outer tube 14 of the sheathed heater 10 and the control unit 100 (an example of detector) configured to detect a current flowing through the outer tube 14 of the sheathed heater 10 via the conductive wire 20.

The configuration above can detect a current leaked to the outer tube 14 of the sheathed heater 10 via the conductive wire 20. Thus, the configuration above can detect whether the sheathed heater 10 is running dry and prevent the sheathed heater 10 from continuing to run in the dry-boiling state without using a thermistor.

The control unit 100 (an example of controller) cuts off a current to the heating element 12 in response to detecting a current flowing through the outer tube 14 of the sheathed heater 10. This configuration can prevent the sheathed heater 10 from reaching a higher temperature, thereby preventing the sheathed heater 10 from continuing to run in the dry-boiling state.

The sheathed heater 10 is attached to the housing 50 that houses the fluid to be heated in an electrically insulated manner from the housing 50. This configuration can prevent a current leaked to the outer tube 14 of the sheathed heater 10 from leaking to the housing 50.

The sheathed heater 10 is electrically insulated from the housing 50 by the sealing member 70 disposed between the sheathed heater 10 and the housing 50. This configuration ensures the insulation between the sheathed heater 10 and the housing 50. Further, the configuration can prevent the fluid housed in the housing 50 from leaking from the gap between the sheathed heater 10 and the housing 50.

The conductive wire 20 is attached to the outer peripheral surface 14a of the outer tube 14 of the sheathed heater 10 at a position closer to an axial end of the sheathed heater 10 than the sealing member 70 is. This configuration allows the conductive wire 20 to be easily pulled out.

(Variant) In the above embodiment, the housing 50 of the fluid heating device 4 comprises the flow passage 55, but this need not always be the case. In a variant, the housing 50 of the fluid heating device 4 may comprise a reservoir (not illustrated) storing fluid for a heating device of the sheathed heater 10. The fluid for the heating device of the sheathed heater 10 may not always flow during the heating by the sheathed heater 10.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is

1. A detection device for detecting leakage current of a sheathed heater, wherein
the sheathed heater comprises a metal outer tube, a heating element housed in the outer tube, and a magnesium oxide insulating material filling the outer tube around the heating element, and
the detection device comprises:
a conductive wire attached to a surface of the outer tube of the sheathed heater; and
a detector configured to detect current flowing through the outer tube of the sheathed heater via the conductive wire.

2. The detection device according to claim 1, further comprising a controller configured to cut off current to the heating element when the detector detects the current flowing through the outer tube of the sheathed heater.

3. The detection device according to claim 1, wherein
the sheathed heater is attached to a housing that houses fluid to be heated, in an electrically insulated manner from the housing.

4. The detection device according to claim 3, wherein
the sheathed heater is electrically insulated from the housing by a sealing member disposed between the sheathed heater and the housing.

5. The detection device according to claim 4, wherein
the conductive wire is attached to the surface of the outer tube of the sheathed heater at a position closer to an axial end of the sheathed heater than the sealing member is.

6. A fluid heating device comprising:
a housing that houses fluid to be heated;
a sheathed heater attached to the housing and configured to heat the fluid housed in the housing; and
a detection device configured to detect leakage current of the sheathed heater,
wherein
the sheathed heater comprises a metal outer tube made, a heating element housed in the outer tube, and a magnesium oxide insulating material filling the outer tube around the heating element, and
the detection device comprises:
a conductive wire attached to a surface of the outer tube of the sheathed heater; and
a detector configured to detect current flowing through the outer tube of the sheathed heater via the conductive wire.

7. The detection device according to claim 2, wherein
the sheathed heater is attached to a housing that houses fluid to be heated, in an electrically insulated manner from the housing.
